(19) United States
(12) Patent Application Publication
(10) Pub. No.: US 2025/0286163 A1
(43) Pub. Date: Sep. 11, 2025

(54) A BATTERY PACK AND A BATTERY MODULE WITH THERMAL MANAGEMENT

(71) Applicant: Saeid HAGHBIN, Ojersjo (SE)

(72) Inventor: Saeid HAGHBIN, Ojersjo (SE)

(21) Appl. No.: 18/596,682

(22) Filed: Mar. 6, 2024

(51) Int. Cl. H01M 10/625; H01M 10/613; H01M 10/643; H01M 10/647; H01M 10/6555; H01M 10/6567; H01M 50/211; H01M 50/213; H01M 50/224; H01M 50/249; H01M 50/264

(52) U.S. Cl. CPC H01M 10/625; H01M 10/613; H01M 10/643; H01M 10/647; H01M 10/6555; H01M 10/6567; H01M 50/211; H01M 50/213; H01M 50/224; H01M 50/249; H01M 50/264; H01M 50/289; H01M 50/298; H01M 2220/20

(57) ABSTRACT

A battery module for use in an electric vehicle is provided. The battery module comprising a battery pack having a plurality of cell modules, each of the plurality of cell module comprises a plurality of battery cells. The battery module is provided with a thermal management system to dissipate the heat generated by the plurality of battery cells, in form of a heat sink. The heat sink is made of aluminum that absorbs the excess heat generated by the plurality of cells in the battery module. The plurality of cells at middle portion is provided with an aluminum tube that absorbs the heat generated by the cells. The aluminum tube is in contact with a structure material provided in different forms to dissipate the absorbed heat.

### FIELD OF THE INVENTION

The present invention relates to the field of thermal management for battery packs in electric vehicle, and more particularly to a battery module structure with thermal management.

### BACKGROUND

Today, electric vehicles have been emerged as key technology solution for a green and sustainable alternative for transportation. The industry is resorting towards rechargeable battery systems to fulfill the consumer need in different application. For the automotive industry, the battery operated electric vehicles are more common solution over fuel energy based vehicles. The electric transportation produces very less air pollution, but the major challenges such as energy efficiency, cost effectiveness, and safety needs to be improved to meet the development goals.

Although, the electric transportation is getting better over time but the structural safety and energy efficiency of the electrical batteries constantly need to be improved with the changing industrial requirements. Currently, the electrical vehicles are facing many thermal safety related issues such as over temperature events causing fire, battery explosion which makes the system very vulnerable to the accidents. There exist many solutions that are implemented to avoid such accidents; however, these solutions are having limitations. One such solution disclosed in an electrical system, recommends disconnection of the energy supply and stopping the operation of electrical vehicle immediately during the over temperature event. However, the conventional solutions are limited to their application in ground based vehicle only and for other applications, such as aeronautical application, these solutions cannot be implemented as the energy supply cannot be stopped and it is impossible to park the airplane in the middle of air.

The aeronautical application faces another major challenge in terms of weight and size of the energy source. Therefore, for the aeronautical applications, the energy sources need more improvements to accommodate thermal safety, power efficiency, light weight, and compact design/size.

Lithium ion cells are favorable options in electric batteries because of high energy and power density values. Lithium cells have high energy content and are very explosive. If a cell is abused by over temperature, or mechanical failure, there is a risk of explosion. The lithium ion cells are compared with TNT materials and can lead to a difficult situation in thermal runaway conditions. In order to mitigate risk associated with the temperature associated event or mechanical failures, more safety features need to be added to the battery structure that in turn increases the weight of the battery unit.

In order to provide safety standards and thermal management for electric batteries for aeronautical applications, various solutions have been proposed in prior art. The conventional battery pack comes equipped with a battery pack cooling system that uses a liquid coolant that circulates inside the battery module to dissipate the heat generated by the batteries. Certain battery pack system utilizes a cooling plate positioned outside the battery cells to dissipate the heat. In the conventional cooling system, liquid (mainly water) is circulated inside the pack and close to the cells via cold plate. In immersion type cooling system, the water or oil is enclosing all the cells. During mechanical failure, the liquid of the coolant system flows into the battery pack and causes serious electrical risks.

There is, therefore, needed a system to solve the aforementioned problems by providing a battery module with a structural design that is light in weight and that protects the cell from fire in adjunct area and remove the heat through the structure.

### SUMMARY

In a first aspect of the present invention, a battery module for use in electric vehicle is provided. The battery module comprising: a plurality of cylindrical cells having a top end, a bottom end and a middle portion arranged in parallel; an extended horizontal metal strip with a plurality of holes at regular interval to hold the plurality of cylindrical cells; a first extended horizontal plastic strip to hold the top end of the plurality of cylindrical cells; a second extended horizontal plastic strip to hold the bottom end of the plurality of cylindrical cells; wherein the extended horizontal metal strip absorb the heat generated by each of the plurality of cylindrical cell.

The extended horizontal metal strip to hold the plurality of cylindrical cells at the middle portion is made of aluminum. The wiring connection of the plurality of cylindrical cells is performed through the first extended horizontal plastic strip and the second extended horizontal plastic strip. The middle portion of the cylindrical cell is in contact with the extended horizontal metal strip to dissipate the heat generated by the plurality of cylindrical cells. The battery module is enclosed in a metallic enclosure made of aluminum. The metallic enclosure is configured to hold a cold plate.

In a second aspect of present invention, a battery module for use in electric vehicle is provided. The battery module comprising a plurality of battery cells enclosed in an aluminum tube; a plurality of aluminum holder to place the plurality of battery cells, wherein the each of the plurality of battery cells is in contact with the plurality of aluminum holder respectively; a metal frame structure to house the plurality of aluminum holder.

The pluralities of cylindrical cells in the battery module are connected with wires at the respective electrodes and the wire connections are covered with plastic holders. In the battery module, an isolation layer is reinforced between the plurality of battery cells and the aluminum holder. The isolation layer is an isolation paper or a resin placed between the plurality of battery cells and the plurality of aluminum holders. The metal frame structure comprising a top wall, a bottom wall and a pair of side walls to house the metallic enclosure. The housing in the metal frame structure is partitioned by a plurality of horizontal metallic plates into a plurality of shelf to house the metallic enclosure. The metal frame structure is configured to hold a cold plate at the top wall, the bottom wall or the pair of side walls. The metal frame structure increases the surface area of heat sink for dissipating heat.

### BRIEF DESCRIPTION OF DRAWINGS

The preferred embodiment of the invention will hereinafter be described in conjunction with the appended drawings provided to illustrate and not to limit the scope of the invention, wherein like designation denote like element and in which:

FIG. 1A illustrates a schematic representation of a standard battery pack and FIG. 1B illustrates exploded view of standard battery pack structure.

FIG. 2 illustrates structure of a cell module with cooling and fire protection structure in accordance with another embodiment of the present invention.

FIG. 3 illustrates a schematic representation of a base module structure in accordance with an embodiment of the present invention.

FIG. 4 illustrates a top view of the base module structure in accordance with an embodiment of the present invention.

FIG. 5 illustrates an assembled base module in accordance with an embodiment of the present invention.

FIG. 6 illustrates a cold plate for cooling the battery module in accordance with an embodiment of the present invention.

FIG. 7 illustrates a representation showing a base module and an external structure to store a plurality of base module to regulate the temperature in accordance with an embodiment of the present invention.

### DETAILED DESCRIPTION

In the following detailed description of embodiments of the invention, numerous specific details are set forth in order to provide a thorough understanding of the embodiments of the invention. However, it will be obvious to a person skilled in the art that the embodiments of the invention may be practiced without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalent to those skilled in the art without parting from the spirit and scope of the invention.

In an embodiment, the present invention, a battery module with structural safety and thermal management for fire protection, and/or heat dissipation is provided. The battery module comprises multiple cells such as pouch or cylindrical form, housed inside an aluminum tube. The aluminum tube or structure includes an insulation material, reinforced isolation like isolation paper or some kind of resin to isolate cells from the aluminum structure. The battery module also comprises an external housing to store the plurality of aluminum tube or structure housing the multiple cells. The external housing has a central/middle part and side walls that are configured to hold the aluminum tube or structure and provide more protection around the aluminum tube, especially in case of a thermal runaway that could be difficult for aluminum tube to withstand. The external housing is made of aluminum and the top, bottom or the side walls of the external housing can be placed with cold plate to dissipate the heat from the central part.

The battery module further comprises a battery management system (BMS) for monitoring the cell temperature, contactors, pack current, and communication towards the vehicle.

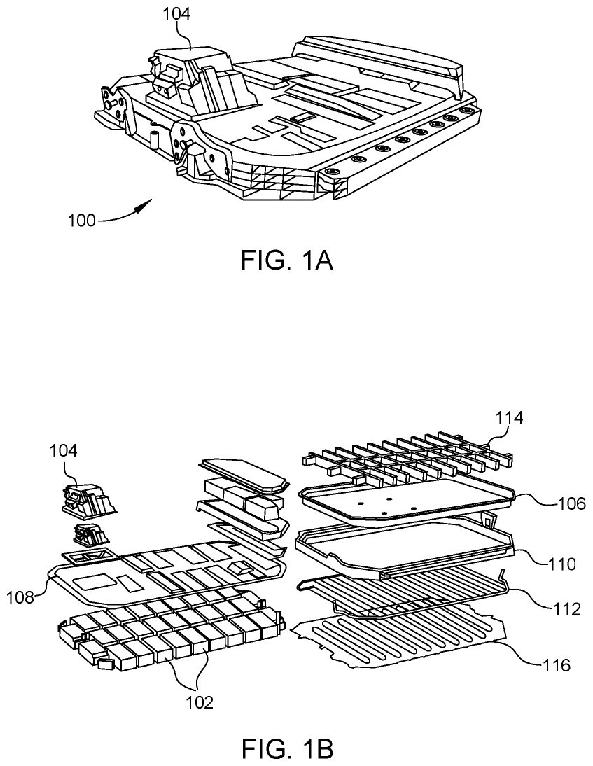

FIG. 1A-1B illustrates a schematic representation of a standard battery pack structure. FIG. 1A illustrates a battery pack structure 100 and FIG. 1B illustrates an exploded view of the battery pack structure 100 known in the art. The battery pack comprises a plurality of cell modules 102 and each of the plurality of cell modules 102 is made of several battery cells. The battery cells are electrochemical cells that provide power and energy. The battery cells in the battery pack structure are preferably Lithium ion cells as they provide high energy and power density values. The battery cells may be in pouch form or in cylindrical form. The cylindrical cell has slightly higher energy and power density values over the pouch cells. The cylindrical cells are preferably used in battery cells to provide higher energy and power density values. Each of the plurality of cell modules 102 in the battery pack has a voltage of 12V or 24 V. Each of the plurality of cell modules are connected in series to provide the required voltage and capacity.

The battery pack 100 has a battery management system 104 to manage a plurality of functions associated with battery pack 100 and the electric vehicle. The battery management system 104 has several functions including monitoring of cells, monitoring of the temperature, controlling the contactors, monitoring of the pack current, communications to the electric vehicle etc.

Each of the plurality of cell modules are arranged in a metallic housing 106 and sealed by a housing cover 108. The metallic housing 106 and the housing cover 108 is preferably made from aluminum to dissipate heat generated by the plurality of cell modules. The battery pack comprises a battery junction box 104 placed on the top of the housing cover that provides provision for electric connection. The housing tray is fitted into a battery frame 110 that protects the battery from the sides. The bottom of the housing tray is provided with a cooling system 112. The top and bottom of the battery pack 100 are provided with an isolation layer in form of an aluminum crash structure 114 and a lower protection cover 116.

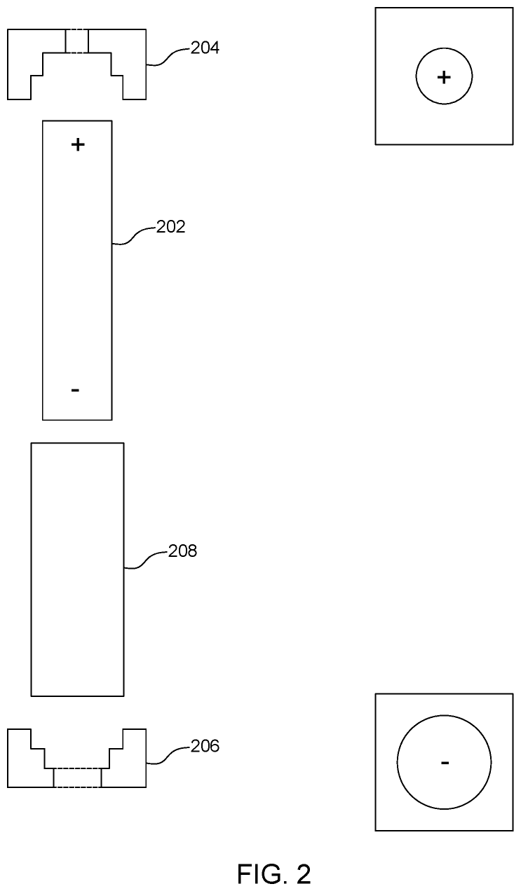

FIG. 2 illustrates structure of a cell module 202 with cooling and fire protection structure in accordance with an embodiment of the present invention. The cell module 202 is cylindrical in shape in which plurality of battery cells are arranged. The two ends of cylindrical cell modules are positive 204 and negative electrode 206. The middle part of the cylindrical cell is enclosed in an aluminum tube 208 that acts as a sink for the heat generate by the cylindrical cell. The two ends of the cylindrical cell are covered by a cover.

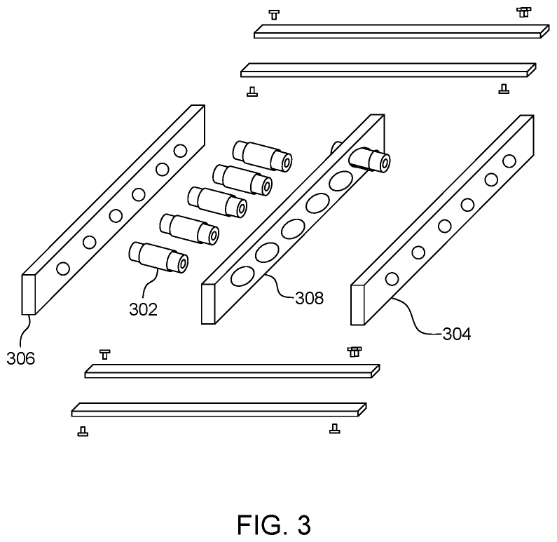

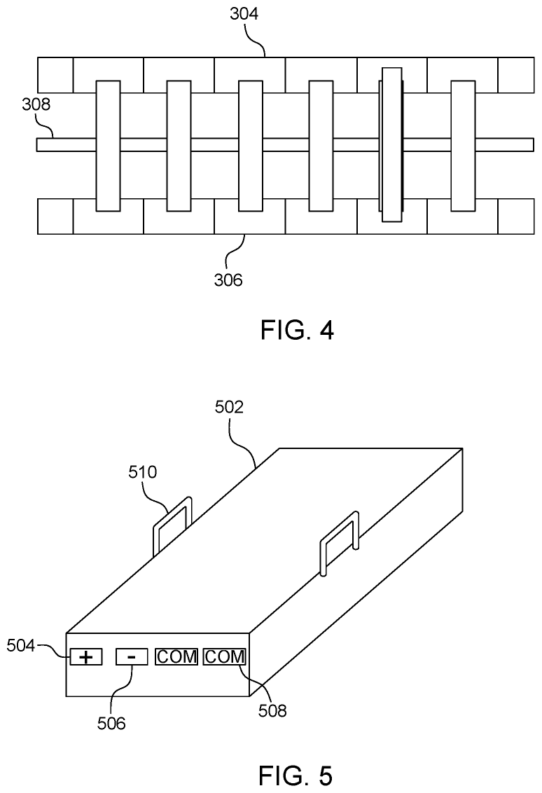

FIG. 3 illustrates a schematic representation of a base module structure in accordance with an embodiment of the present invention. FIG. 4 illustrates a top view of the base module structure in accordance with an embodiment of the present invention. Referring to FIGS. 3 and 4, the base module comprises a plurality of cylindrical cells 302 arranged parallel to each other. The top and bottom of each of the plurality of cylindrical cells are covered with the top end cover 304 and bottom end cover 306 made of plastic, carbon fiber or similar materials. The cell wiring and the fusing are performed through the end covers. The middle portion of each of the plurality of cylindrical cells is covered with aluminum tube 308. The middle portion is passed through an aluminum heat sink 308 which is an elongated tube like structure having holes at regular interval to let each of the plurality of cylindrical cells 302 to pass through, such that the middle portion with aluminum tube 308 is in contact with the aluminum heat sink. The aluminum tube 308 in the middle portion of the cylindrical cell absorbs the heat generated by the cylindrical cell 302 and transfers the heat to the aluminum heat sink which dissipates the heat to the outside.

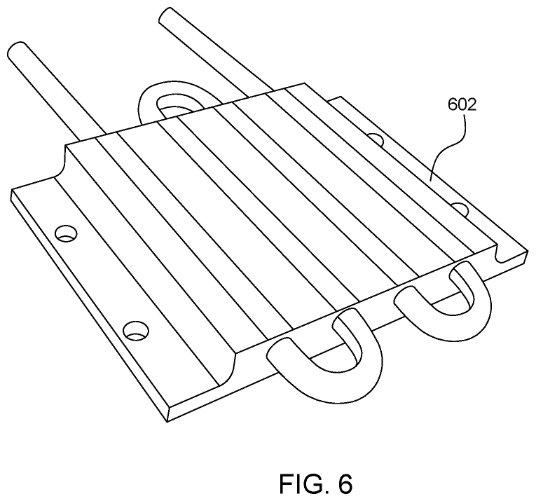

FIG. 5 illustrates an assembled base module in accordance with an embodiment of the present invention. The battery pack is enclosed in a metallic enclosure 502 in shape of a cuboidal box. The enclosure 502 is preferably made of aluminum metal for better conduction of heat. The battery pack enclosed inside the metallic enclosure 502 is a battery module for performing operation in an electric vehicle. The battery module comprises a connection port for positive 504 and negative electrode 506 and one or more communication port 508. A pair of clamps 510 is provided on the top side of the enclosure that serves as a handle to hold the battery pack. The base of the top plate of the enclosure is used for placing a cold plate to cool the battery pack. Referring to FIG. 6, a cold plate 602 for cooling the battery pack is illustrated. The cold plate 602 is a standard cold plate with coils for circulating cold liquid. The cold plate 602 when placed over the top side of the battery pack absorbs heat generated by the battery pack.

In another embodiment of the present invention a system to prevent fire spread to adjacent cells in a battery pack is provided. The system provide an extended shield around a battery cell to protect the fire spread to adjacent battery cells and dissipating heat using an aluminum heat sink. The conventional system uses extended aluminum sheet in contact with the battery cells to eliminate heat, wherein the cold plate is in direct contact with battery cells or water is circulated in the system through channel which causes a risk of explosion.

The battery module of the present invention is configured to be installed with a cold plate outside the module. The battery module has an isolation layer reinforced between the extended aluminum sheet and the cells. The isolation is performed by placing an isolation paper or some kind of resin between the cells and the aluminum structure. The aluminum tube in the middle portion of each of the plurality of cylindrical cell provides cooling functionality. The battery modules can be multiplied by adding several battery module units side by side to do series or parallel connection. The connection between the battery modules is done by bonding or wiring with some fuse on top cover.

The aluminum tube act as a heat sink to dissipate the heat generated by the battery cells. The aluminum tube isolates each cell from the adjacent cell and thus the structure is capable to damp fire by the unique structure.

The battery module can work with or without cold plate to remove the heat. Each of the plurality of cells is covered with an aluminum tube at the middle portion that takes away heat from the central part of the cylindrical cell. The aluminum tube at the middle portion transfers the heat to the extended aluminum sheet, which diffuses the heat either through cold plate or without cold plate.

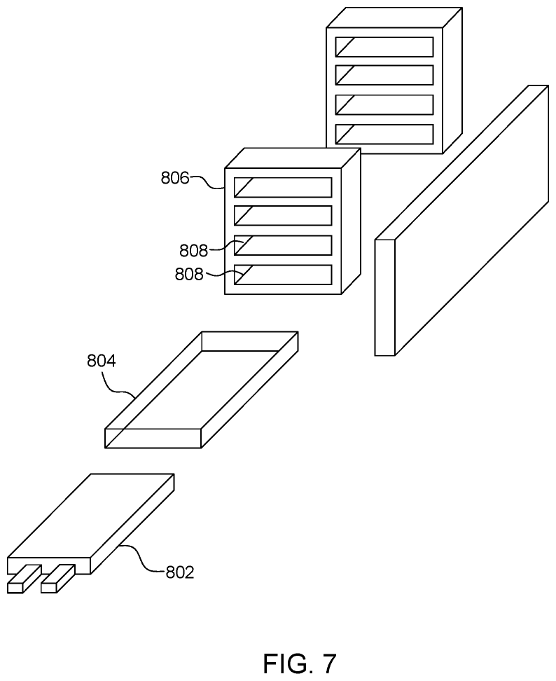

In another embodiment a system to dissipate heat form the battery cells of electric vehicle is provided. The battery module of the embodiment uses pouch cells for powering the electric vehicle. Referring to FIG. 7, the structure comprises a battery pack unit 802, an aluminum cell holder 804 and an aluminum frame structure 806. The battery pack unit 802 is a pouch cell or a unit made of cylindrical cells and is placed in an aluminum cell holder or tube 804. The aluminum cell holder or tube 804 is used to collect heat from the battery pack unit 802. The aluminum frame structure 806 is a panel with a plurality of shelf 808 for housing the plurality of aluminum cell holder or tube 804. The shelf type aluminum frame structure 806 increases the surface area of contact with battery pack to dissipate heat generated by the battery cell by acting as a heat sink. The shelf type aluminum frame structure 806 comprises a bottom wall, a pair of side wall and a top wall. The central space of the aluminum frame structure is divided into a plurality of shelf 808 by providing plates parallel to the top wall and the bottom wall. The plurality of shelf is used to place the plurality of aluminum cell holder or tube 804 containing the battery pack unit 802. The large surface area of the aluminum frame structure allows more heat to dissipate through it. In order to provide cooling effect to the aluminum frame structure, one or more cold plate is placed at the top wall or side wall or the bottom wall.

The battery modules described in various embodiments of the present invention finds its application in electric vehicle and aeronautical applications. The battery modules having aluminum as metallic component are light in weight and design and construction of batteries make it efficient or use in aeronautical applications, such as in electric airplane or eVTOL (electric vehicle take-off and landing). The constructional features of the battery module of the present invention provide an external shield around a battery cell so as to prevent the fire spread to adjacent area and remove excess heat through the structure. The battery module of the present invention complies with the requirement of RTCA DO-311 standard such that if more than 20 percent of the battery cell is on fire, the rest of the cell are able to deliver the energy to the airplane for emergency procedure.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

What is claimed is:

1. A battery module for use in electric vehicle comprising:
a plurality of cylindrical cells having a top end, a bottom end and a middle portion arranged in parallel;
an extended horizontal metal strip with a plurality of holes at regular interval to hold the plurality of cylindrical cells;
a first extended horizontal plastic strip to hold the top end of the plurality of cylindrical cells;
a second extended horizontal plastic strip to hold the bottom end of the plurality of cylindrical cells;
wherein the extended horizontal metal strip absorb the heat generated by each of the plurality of cylindrical cell.

2. The battery module of claim 1, wherein the extended horizontal metal strip is made of aluminum.

3. The battery module of claim 1, wherein the wiring connection of the plurality of cylindrical cells are performed through the first extended horizontal plastic strip and the second extended horizontal plastic strip.

4. The battery module of claim 1, wherein the middle portion of the cylindrical cell is in contact with the extended horizontal metal strip to dissipate the heat generated by the plurality of cylindrical cells.

5. The battery module of claim 1, wherein the battery module is enclosed in a metallic enclosure.

6. The battery module of claim 5, wherein the metallic enclosure is made of aluminum.

7. The battery module of claim 5, wherein the metallic enclosure is configured to hold a cold plate.

8. A battery module for use in electric vehicle comprising:
a plurality of battery cells enclosed in an aluminum tube;
a plurality of aluminum holder to place the plurality of battery cells, wherein the each of the plurality of battery cells is in contact with the plurality of aluminum holder respectively;
a metal frame structure to house the plurality of aluminum holder.

9. The battery module of claim 8, wherein the plurality of battery cells are connected with wires at the respective electrodes.

10. The battery module of claim 8, wherein wire connections are covered with plastic holders.

11. The battery module of claim 8, wherein an isolation layer is reinforced between the plurality of battery cells and the plurality of aluminum holders.

12. The battery module of claim 8, wherein the battery cells are pouch cells.

13. The battery module of claim 11, wherein the isolation layer is an isolation paper or a resin placed between the plurality of battery cells and the plurality of aluminum holders.

14. The battery module of claim 8 wherein the metal frame structure comprising a top wall, a bottom wall and a pair of side walls to house the metallic enclosure.

15. The battery module of claim 8, wherein the housing in the metal frame structure is partitioned by a plurality of horizontal metallic plates into a plurality of shelf to house the metallic enclosure.

16. The battery module of claim 8, wherein the metal frame structure is configured to hold a cold plate at the top wall, the bottom wall or the pair of side walls.

17. The battery module of claim 8, wherein the metal frame structure increases the surface area of heat sink for dissipating heat.
